(19) United States
(12) Patent Application Publication
(10) Pub. No.: US 2004/0070127 A1
(43) Pub. Date: Apr. 15, 2004

(54) Torsion bar for a seat belt retractor

(76) Inventors: Klaus Junker, Diessen a. Ammersee (DE); Andreas Tull, Germering (DE)

Correspondence Address: KEY SAFETY SYSTEMS, INC., PATENT DEPARTMENT, 5300 ALLEN K BREED HIGHWAY, LAKELAND, FL, 33811-1130, US

(21) Appl. No.: 10/648,305

(22) Filed: Aug. 27, 2003

(30) Foreign Application Priority Data
Oct. 15, 2002 (DE) 202 15 831.4

(51) Int. Cl. F16F 1/14

(52) U.S. Cl. 267/154

(57) ABSTRACT

A torsion bar that can be installed in a seat belt retractor as an energy absorber has a gear integral therewith, wherein the gear is created by submitting the torsion bar to a rolling operation.

### FIELD OF THE INVENTION

The present invention relates to a torsion bar and at least one gear that can be installed in a seat belt retractor as an energy absorber.

### DISCUSSION OF THE PRIOR ART

DE 196 53 510 A1 teaches the use of a torsion bar as an energy absorber in a belt reel of a seat belt retractor. In order to connect the torsion bar in a non-rotatable manner with a lockable part of the belt reel, for instance a toothed disk and with a belt reel part which can be rotated in the case of overloading, gears are located on the two ends and/or in the bar region between the two ends on the torsion bar. Gears corresponding to the toothed disc and the rotatable belt reel part engage the gears located on the torsion bar. The torsion bars with the anchoring gears associated therewith are manufactured in a conventional manner by compression molding.

### SUMMARY OF THE INVENTION

According to the invention at least one gear is created by rolling of the torsion bar material that is preferably arranged at an end of the torsion bar or in the proximity of the bar end. In addition, the bar end can comprise a surrounding flange, in the proximity of which the gear is arranged. The flange is located on the bar end on which a toothed disc associated with a lockable gear is to be connected in a non-rotatable manner with the adjacent gear. The flange is used as a catch for axial fixation of the toothed disc.

It is preferable that between the flange and the gear a circumferential groove is located, which works as a “relief groove” and prevents an influencing of the shaping during the production of the gear by the rolling process. It is preferable that during the shaping of the gear through rolling, the circumferential groove that acts as a relief groove is also formed by rolling. The groove is preferably deeper in a radial direction than the gear.

The shaping of the gear preferably takes place using two rolling cylinders that are diametrically set up on the bar material and have forming gears on their peripheries. The two rolling cylinders are put to use on diametrically opposed sides of the bar material.

The surrounding flange can be provided on the bar end prior to the rolling process, for instance by molding. The side of the flange turned towards the gear can preferably serve as a support surface for the rolling tool, namely the rolling cylinder.

The rolling tool in each case can be designed in such a manner that the required insertion, the circumferential groove, is also molded during the rolling process, during which the gear, namely the anchoring gear, is impressed in the bar material. To this effect the rolling tool, apart from the shaping contour for the gear, also comprises the shaping contour for the formation of the circumferential groove.

### BRIEF DESCRIPTION OF THE DRAWINGS

FIG. 1 is a perspective view of an embodiment of the torsion bar with two gears, namely anchoring gears, located on the ends of the bar.

FIG. 2 shows the embodiment of FIG. 1 with a toothed disc connected on one end of the torsion bar in a non-rotatable manner one of the gears.

FIG. 3 is a side view of the embodiment illustrated in FIG. 2.

FIG. 4 is a sectional representation of the embodiment of FIG. 3 taken along line 4-4 of FIG. 2.

FIG. 5 shows an embodiment for a bar end provided with a gear and on which a toothed disc can be secured in accordance with FIGS. 2 to 4.

FIG. 6 is a sectional representation of the embodiment of FIG. 5 taken along line 6-6 of FIG. 5.

FIG. 7 is a sectional representation of a further embodiment of a bar end provided with a gear.

FIG. 8 is a sectional representation of a further embodiment of a bar end provided with a gear, on which a toothed disc can be secured.

FIG. 9 is a sectional representation of diametrically arranged rolling tools that are arranged at a distance from the bar end.

FIG. 10 is a sectional representation of the arrangement of the rolling cylinders on the bar end during the rolling process with a second embodiment of rolling cylinders.

FIG. 11 is a sectional representation of a third embodiment of a rolling cylinder.

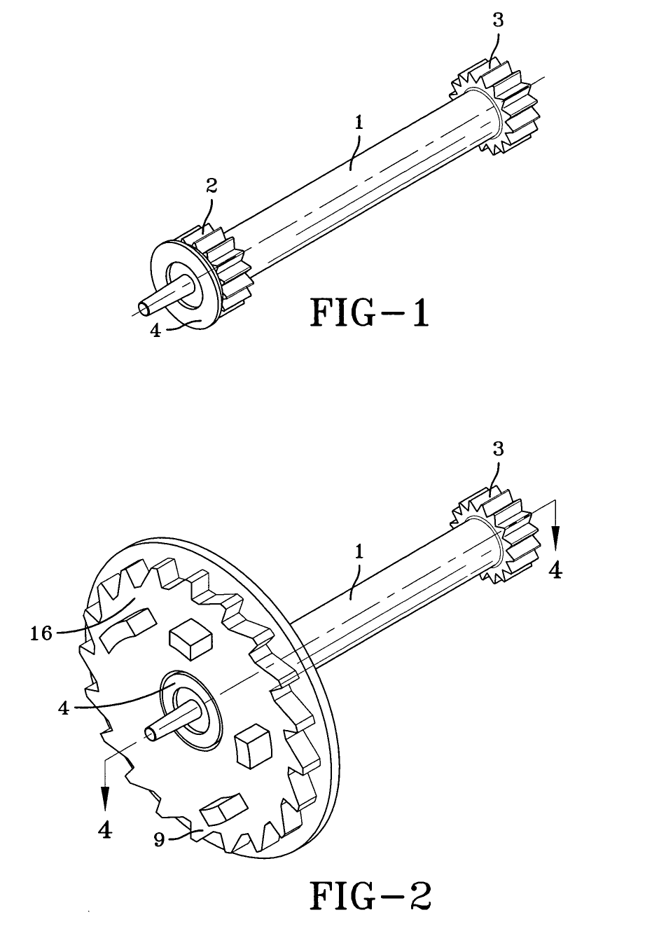

### DETAILED DESCRIPTION OF THE INVENTION

The embodiment of a torsion bar shown in the figures comprises a torsion bar 1,on the two ends of which gears 2, 3 integral with the torsion bar are located. On the end of the torsion bar on which a toothed disc 16 is to be secured to the torsion bar in a non-rotatable manner by a first gear 2, a surrounding flange 14 can be located on the bar end, projecting radially beyond the gear. This surrounding flange 14 serves as a catch for the axial and secure positioning of the toothed disc 16 on the torsion bar. On the other end of the torsion bar 1 a second gear 3 is located. A not further represented belt reel part is also connected to second gear 3 in a non-rotatable and positive locking manner. The seat belt webbing is wound up on this rotatable belt reel part in a known manner.

The toothed disc 16 comprises on its circumferential periphery a toothed rim in the form of a crown gear, which acts as a locking gear 9. In a known manner, a not further represented locking element supported on the belt retractor frame, for instance in the form of a latch, can engage the locking gear 9 to lock the belt reel against further rotation on the belt retractor frame in a known manner, in particular in the direction of the belt extraction.

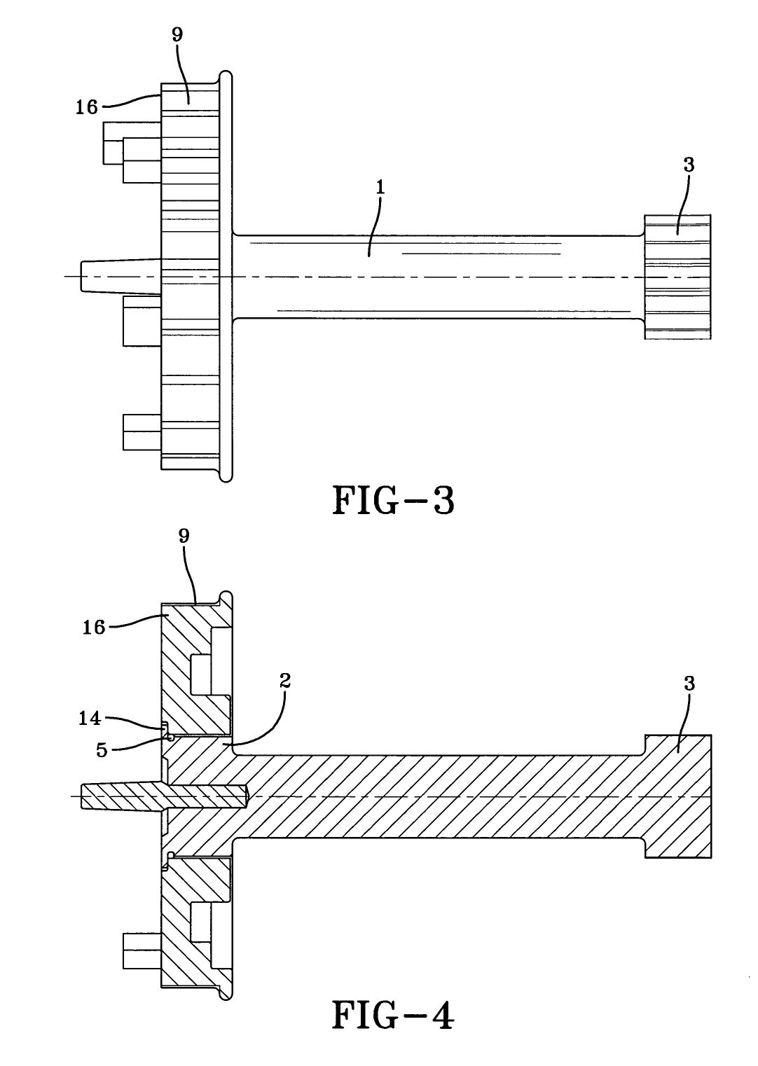

For the purpose of a non-rotatable connection of the toothed disc 16 with the torsion bar, the toothed disc 16 comprises an inner lying toothed rim, which engages the second gear 3 in a positive locking, that is to say an interlocking, manner as shown in FIG. 4. It can also be seen from FIG. 4 that the toothed disc 16 lies against the surrounding flange 14.

In the case of an excessive pulling force originating from the belt webbing, this belt reel part can rotate against the toothed disc 16 locked against rotation. In this type of rotation the torsion bar 1 is twisted, whereby energy is used.

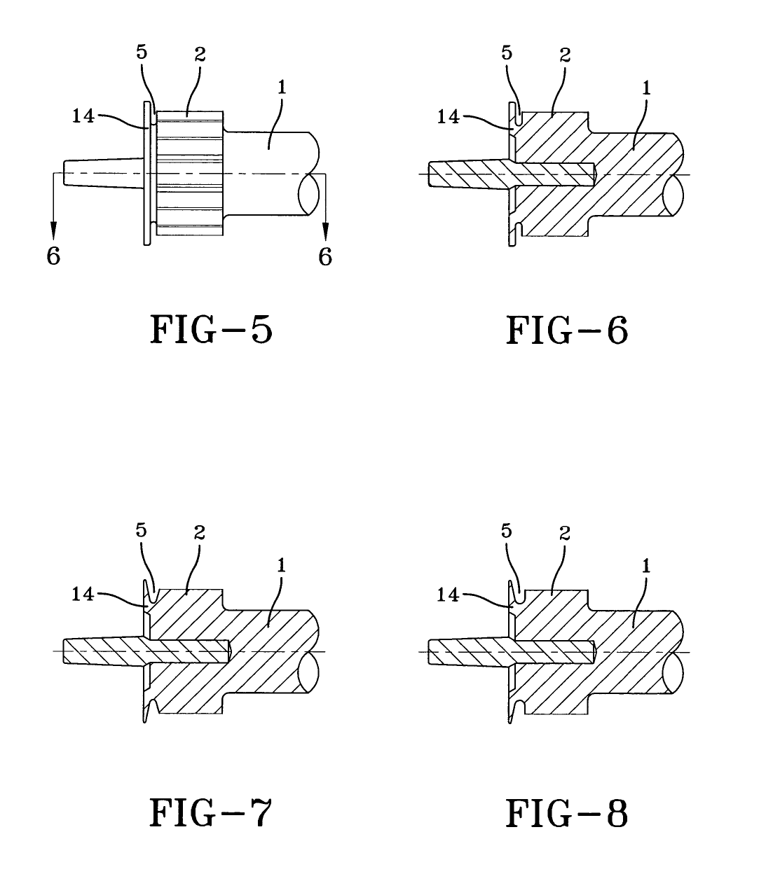

For a simple molding of the gears 2, 3 on the bar material according to the invention, the two gears, or at least the first gear 2 adjacent to the surrounding flange 16, are molded onto the torsion bar material by a rolling process. During this rolling process a circumferential groove 5 is also formed by a rolling process on the bar end, on which the surrounding flange 14 is located. The circumferential groove 5 is located between the surrounding flange and the first gear 2, as can be seen in FIGS. 5 to 9.

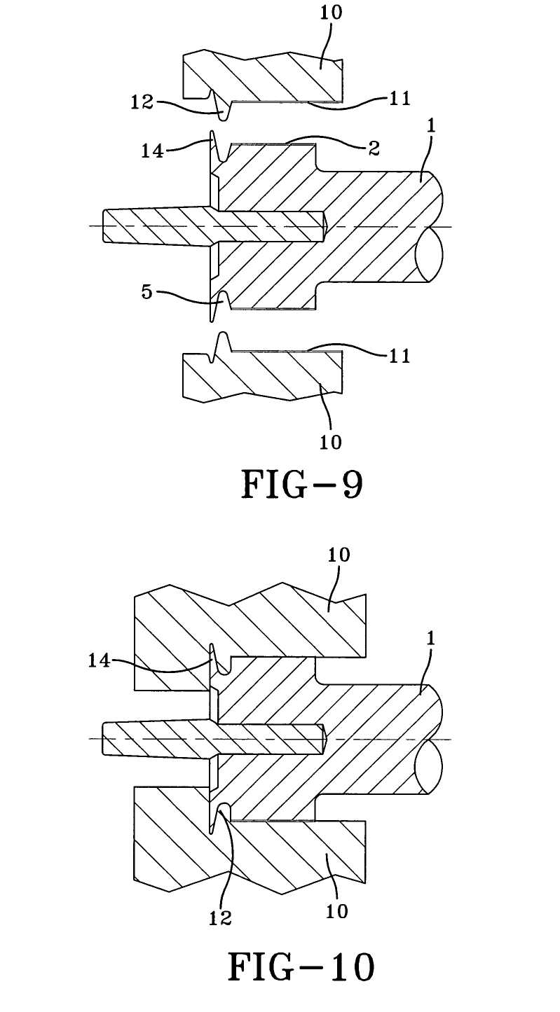

For the molding of the gears 2, 3 and in particular of the first gear 2, the torsion bar can provide the base material with a molded flange 14 prior to the rolling process. During the rolling process the side of the flange 14 facing towards the gear can serve as a support surface for the rolling tool, namely the rolling cylinder. As can be seen in FIGS. 9 and 10, two rolling tools 10 are brought into use, which comprise shaping gears 11 on their peripheral surfaces. Using these shaping gears, the toothed rims 11, the first gear 2 is formed by plastic deformation of the bar material. In this case it is preferable that two rolling tools are set up on the torsion bar in a diametrically opposed arrangement as shown in FIG. 10. Due to a surrounding shaping projection 12 on each rolling tool 10, the circumferential groove 5 is simultaneously molded into the bar material between the surrounding flange 14 and the first gear 2.

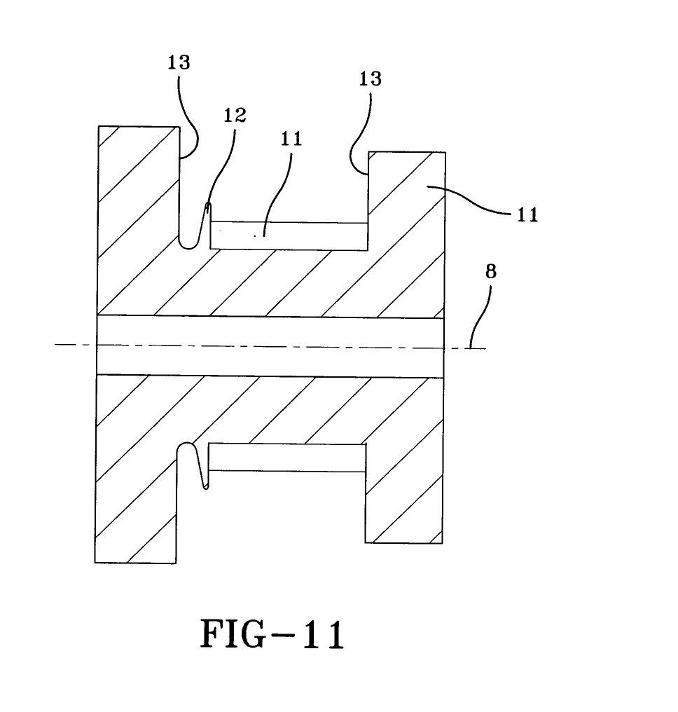

It can further be seen in FIGS. 5 to 10 that the groove 5 extends more deeply into the bar material in a radial direction than the circumferential periphery of first gear 2. Accordingly, the surrounding shaping projection 12 is higher than the shaping gear 11 on the rolling tool 10, as shown in FIGS. 9 to 11. In particular in the rolling tools of FIGS. 10 and 11, a pushing away of the material during the rolling in an axial direction of the torsion bar is avoided by the support surfaces 13. The torsion bar is to this effect adjacent to the support surfaces 13 in the region of the flange 14 and at least of the first gear 2, flush with the tool.

The process being brought into use in the invention is defined in that for the formation on the torsion bar of the gears 2 and/or 3 the corresponding bar parts are rolled, and by plastic deformation of the bar material a gear 2, 3 is created. It is preferred that at the same time as this rolling process the circumferential groove 5 is also molded into the bar material between the flange 14 on the bar end and the first gear 2 at the same time by the rolling process.

During the rolling process, preferably two rolling tools 10, namely rolling cylinders, are used, which are set up on the bar material in a diametrically opposed manner. The bar material is therefore, as is shown in FIG. 10, positioned between the two rolling tolls 10, which are rotated around their axes 8 in each case. In FIGS. 9 and 10 the tool positioned in each case on the bar material is represented in a sectional view.

During the rolling process, the two rolling tools are loaded with a cylinder force radially directed to the bar material, whereby the plastic deformation of the bar material which is weaker than the tool material, correspondingly takes place.

The support surfaces 13 can serve as support surfaces on the two ends of the rolling, as is shown in FIG. 11, or only essentially on the side of the flange, as shown in FIG. 10, or they can be absent, as shown in FIG. 9.

The groove 5 can have various shapes. In the embodiment of FIGS. 5 and 6, the groove comprises side boundary surfaces running essentially parallel, as they are projecting in a radial direction. The cross section of the groove 5 is essentially U-shaped.

In the embodiment of FIG. 7, the groove 5 comprises obliquely running side boundary surfaces. The cross section of the groove is essentially V-shaped.

In the embodiment shown in FIG. 8 the groove 5 comprises a side boundary surface running obliquely to the bar axis and a side boundary surface running essentially perpendicularly to the bar axis. The obliquely running side boundary surface is adjacent to the flange 5 and the side boundary surface running perpendicularly to the bar axis is adjacent to the first gear 2.

FIG. 9 shows rolling tools 10 that are suitable for the production of the embodiment shown in FIGS. 7 and 10 shows rolling tools 10 that are suitable for the production of the embodiment shown in FIG. 8.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

We claim:

1. A torsion bar that can be installed in a seat belt retractor as an energy absorber, comprising a torsion bar and a gear integral therewith, wherein the gear is created by submitting the torsion bar to a rolling operation.

2. The torsion bar according to claim 1, wherein the gear is arranged at an end of the torsion bar.

3. The torsion bar according to claim 1, wherein the gear is arranged near an end of the torsion bar.

4. The torsion bar according to claim 1, wherein a flange integral with the torsion bar is located at an end of the torsion bar with a circumferential groove in the bar disposed between the flange and the gear.

5. The torsion bar according to claim 3, wherein a flange integral with the torsion bar is located at an end of the torsion bar with a circumferential groove in the bar disposed between the flange and the gear.

6. The torsion bar according to claim 4, wherein the circumferential groove is created by a rolling operation.

7. The torsion bar according to claim 5, wherein the circumferential groove is created by a rolling operation.

8. The torsion bar according to claim 4, wherein the circumferential groove extends into the bar material more deeply in a radial direction than a circumferential periphery of the adjacent gear.

9. The torsion bar according to claim 5, wherein the circumferential groove extends into the bar material more deeply in a radial direction than a circumferential periphery of the adjacent gear.

10. The torsion bar according to claim 6, wherein the circumferential groove extends into the bar material more deeply in a radial direction than a circumferential periphery of the adjacent gear.

11. The torsion bar according to claim 7, wherein the circumferential groove extends into the bar material more deeply in a radial direction than a circumferential periphery of the adjacent gear.

12. The torsion bar according to claim 1, further comprising a second gear integral with the torsion bar located at another end of the torsion bar.

13. The torsion bar according to claim 4, further comprising a second gear integral with the torsion bar located at another end of the torsion bar.

14. The torsion bar according to claim 5, further comprising a second gear integral with the torsion bar located at another end of the torsion bar.

15. The torsion bar according to claim 6, further comprising a second gear integral with the torsion bar located at another end of the torsion bar.

16. The torsion bar according to claim 7, further comprising a second gear integral with the torsion bar located at another end of the torsion bar.

17. The torsion bar according to claim 12, wherein the second gear is created by submitting the torsion bar to a rolling operation
